(19) United States
(12) Patent Application Publication
(10) Pub. No.: US 2013/0292499 A1
(43) Pub. Date: Nov. 7, 2013

(54) GLUE-DRIPPING NEEDLE STRUCTURE

(71) Applicants: Wei-Cheng CHU, Taichung City (TW); Wei-Che Weng, Puli Township (TW); Hsin-Ying Hsieh, Taichung City (TW); Yung-Feng Tsou, Hsinchu City (TW); Chang-Chun Lo, Pingzhen City (TW)

(72) Inventors: Wei-Cheng CHU, Taichung City (TW); Wei-Che Weng, Puli Township (TW); Hsin-Ying Hsieh, Taichung City (TW); Yung-Feng Tsou, Hsinchu City (TW); Chang-Chun Lo, Pingzhen City (TW)

(21) Appl. No.: 13/462,479

(22) Filed: May 2, 2012

(51) Int. Cl. A62C 31/02

(52) U.S. Cl. 239/589

(57) ABSTRACT

A glue-dripping needle structure includes a needle body. The needle body includes glue storage cylinder portion and a connection seat portion. The glue storage cylinder portion has an open end and a closed end. The outer surface of the closed end is provided with a plurality of needle heads and protrusions. When in use, the needle heads and the protrusions are perpendicular to a lens module to be processed. Through the plurality of needle heads disposed around the closed end of the glue storage cylinder portion, the glue drips on the periphery of the lens module evenly. There is no need to move the needle body for dripping glue many times. The present invention provides a stable glue-dripping, without worrying about deflection of glue, much glue or less glue.

### BACKGROUND OF THE INVENTION

1. Field of the Invention

The present invention relates to a glue-dripping needle structure, and more particularly, to a glue-dripping needle structure for a lens module.

2. Description of the Prior Art

The build-in cameras of cell phones are popularized and the demand for digital cameras and digital video cameras is increasing, so the demand for optical lenses is increasing progressively. Accurate glue-dripping is very important for assembly of lenses, which will influence the quality of assembling the parts of the lenses.

As shown in FIG. 7, a conventional glue-dripping device comprises a duct (30) coupled with needles (31) to drip glue. The duct (30) with the needles (31) is turned for operation. The glue in the duct (30) drips on the periphery of a lens through the needles (31). The conventional glue-dripping device has the following problems.

1. Abnormality of glue-dripping: The duct with the needles is turned for operation. The glue in the duct drips on the periphery of the lens through the needles. The needles may deflect to result in deflection of glue-dripping, so the glue-dripping will be abnormal.

2. Unstable glue-dripping: The duct with the needles is turned for operation. The glue in the duct drips on the periphery of the lens through the needles. The outputted glue is unstable. Sometimes, the glue is too much or too less.

Accordingly, the inventor of the present invention has devoted himself based on his many years of practical experiences to solve these problems.

### SUMMARY OF THE INVENTION

The primary object of the present invention is to provide a glue-dripping needle structure which comprises a needle body. The needle body comprises a glue storage cylinder portion and a connection seat portion. The connection seat portion has a plurality of connection holes. The glue storage cylinder portion has an open end and a closed end. The open end has a glue storage trough therein. The outer surface of the closed end is provided with a plurality of needle heads and protrusions. The needle heads communicate with the glue storage trough of the open end. The needle heads and the protrusions on the outer surface of the closed end of the glue storage cylinder portion are respectively spaced from one another at 60 degrees. When in use, the connection seat portion is connected to a retaining mechanism through the connection holes cooperating with a plurality of connection members. The needle heads and the protrusions at the closed end of the glue storage cylinder portion are perpendicular to a lens module to be processed. Through the plurality of needle heads disposed around the closed end of the glue storage cylinder portion, the glue drips on the periphery of the lens module evenly. There is no need to move the needle body for dripping glue many times. The present invention provides a stable glue-dripping, without worrying about deflection of glue, much glue or less glue.

### BRIEF DESCRIPTION OF THE DRAWINGS

FIG. 1 is a perspective view according to a preferred embodiment of the present invention;

FIG. 2 is a side sectional view according to the preferred embodiment of the present invention;

FIG. 3 is an enlarged view according to the preferred embodiment of the present invention;

FIG. 4 is a bottom view according to the preferred embodiment of the present invention;

FIG. 5 is a partial bottom view according to the preferred embodiment of the present invention; and

FIG. 6 is a schematic view of the preferred embodiment of the present invention in an operation state.

FIG. 7 is a schematic view of a conventional glue-dripping device.

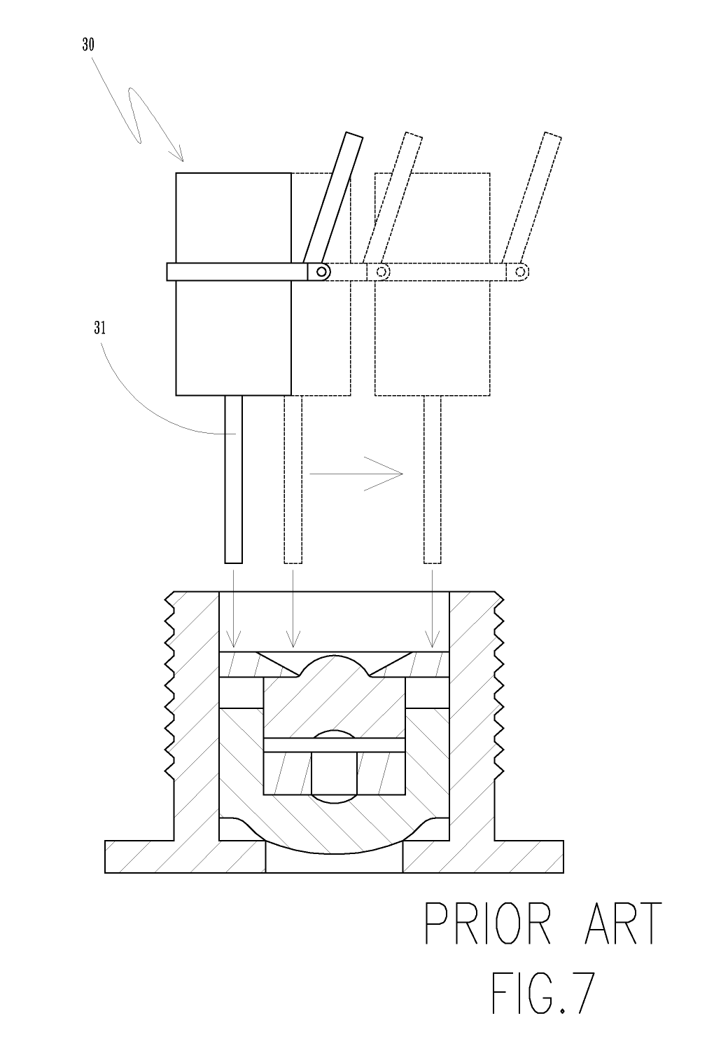

### DETAILED DESCRIPTION OF THE PREFERRED EMBODIMENTS

Embodiments of the present invention will now be described, by way of example only, with reference to the accompanying drawings.

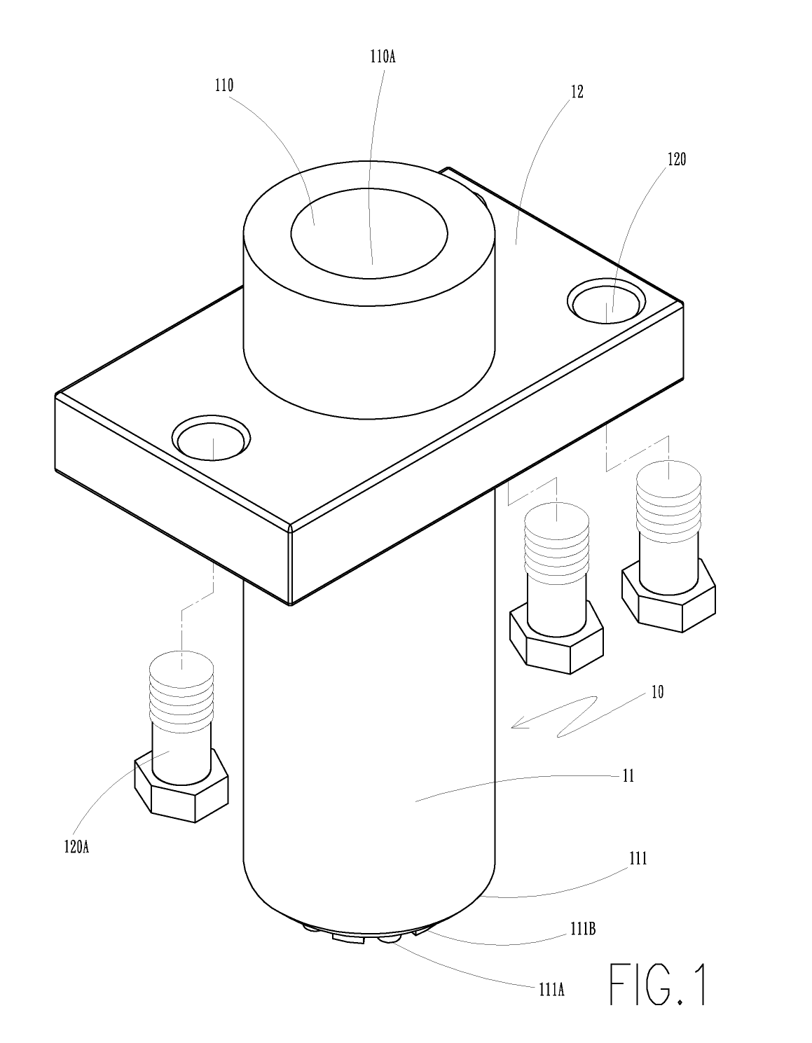

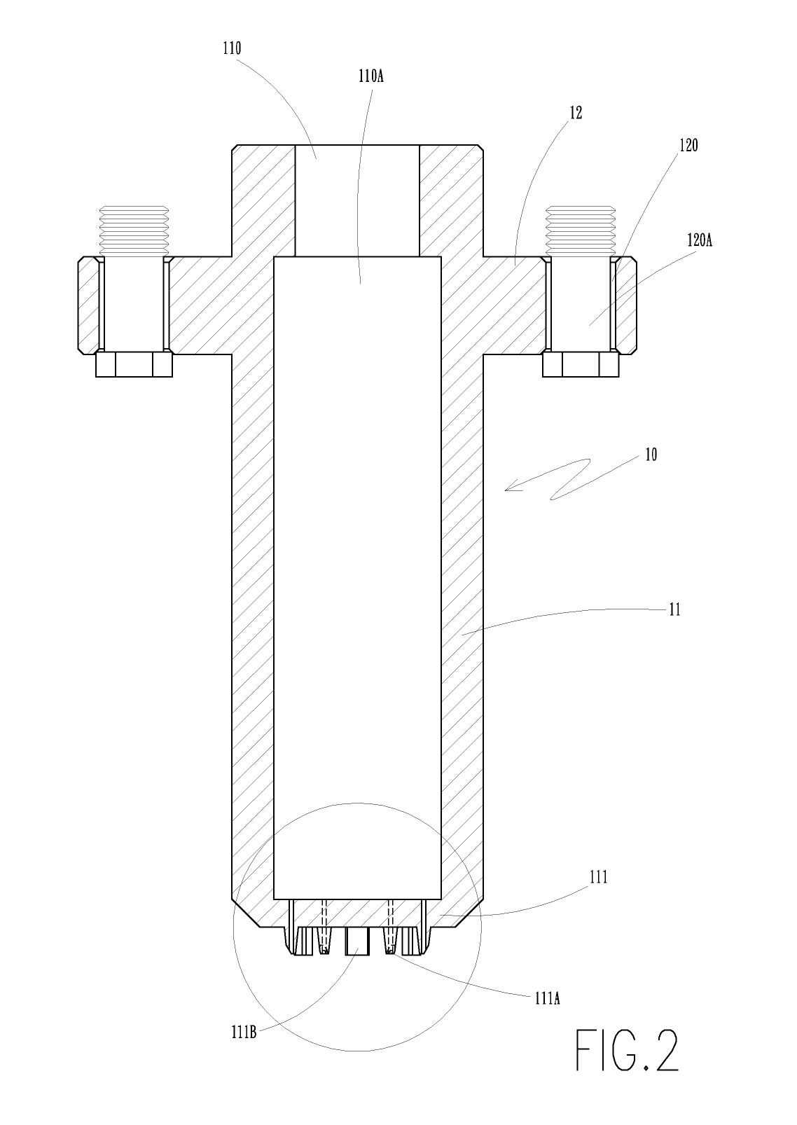

FIG. 1 is a perspective view according to a preferred embodiment of the present invention. FIG. 2 is a side sectional view according to the preferred embodiment of the present invention. As shown in FIG. 1 and FIG. 2, the glue-dripping needle structure of the present invention comprises a needle body (10). The needle body (10) comprises a glue storage cylinder portion (11) and a connection seat portion (12). The connection seat portion (12) is disposed at an upper section of the glue storage cylinder portion (11). The connection seat portion (12) has a plurality of connection holes (120). The glue storage cylinder portion (11) has an open end (110) and a closed end (111). The open end (110) has a glue storage trough (110A) therein. The outer surface of the closed end (111) is provided with a plurality of needle heads (111A) and protrusions (111B). The needle heads (111A) communicate with the glue storage trough (110A) of the open end (110). The needle heads (111A) and the protrusions (111B) on the outer surface of the closed end (111) of the glue storage cylinder portion (11) are respectively spaced from one another at 60 degrees.

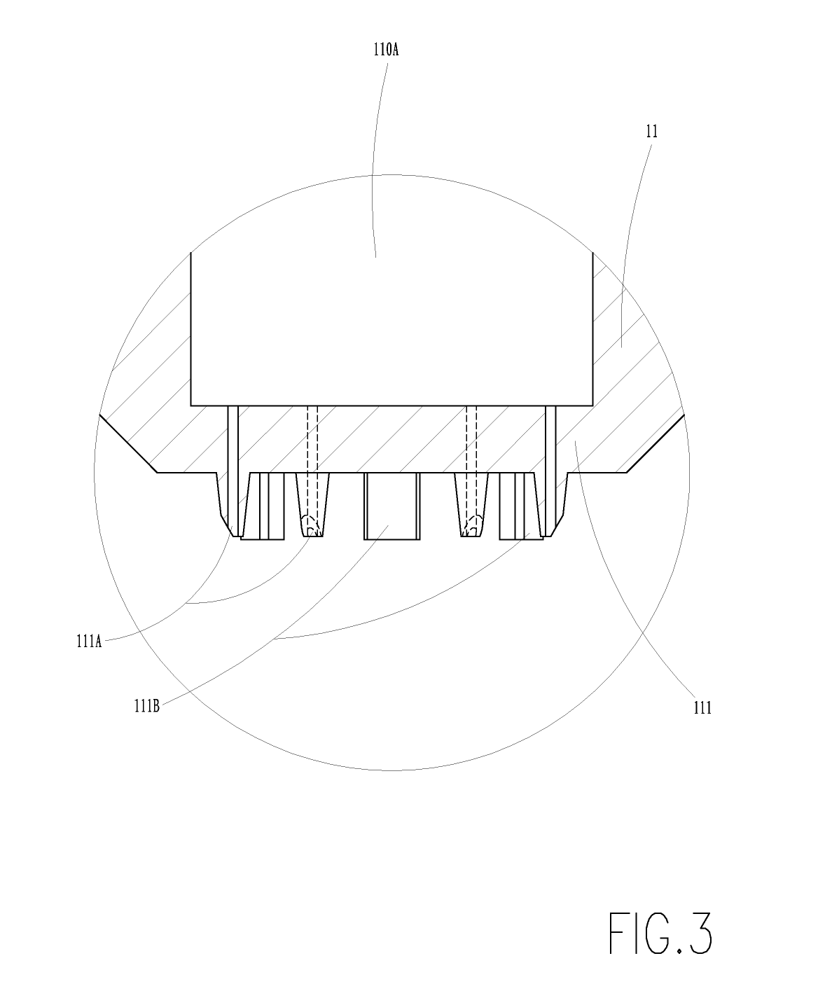

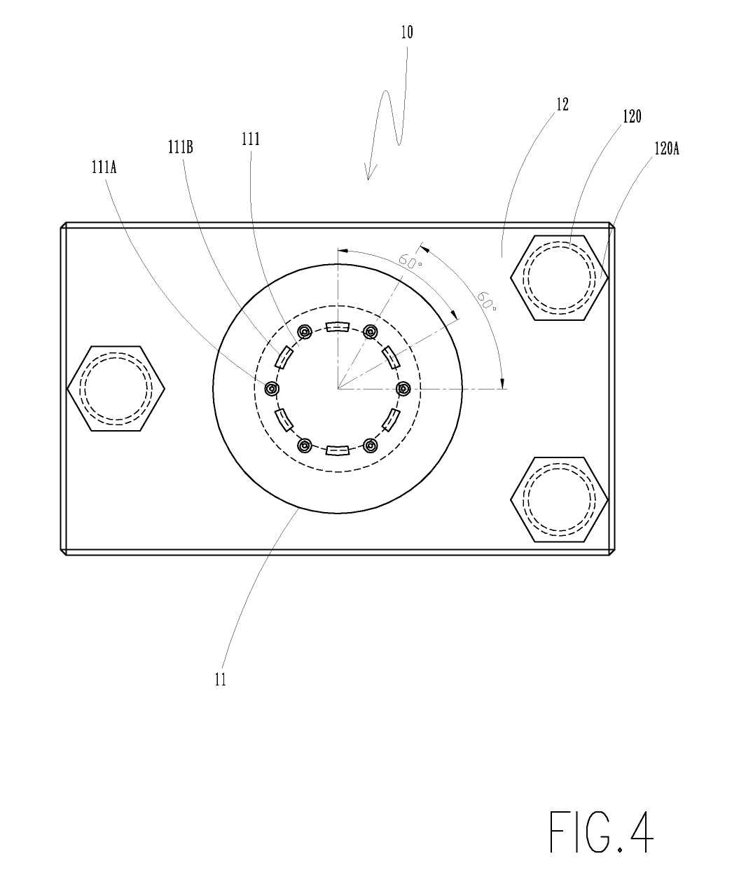

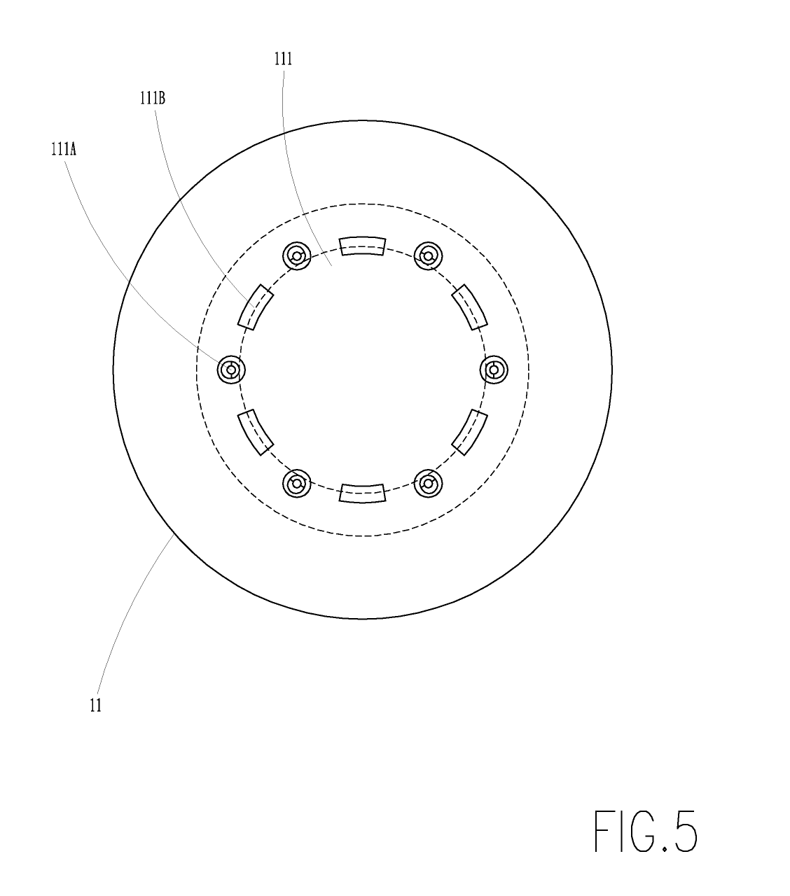

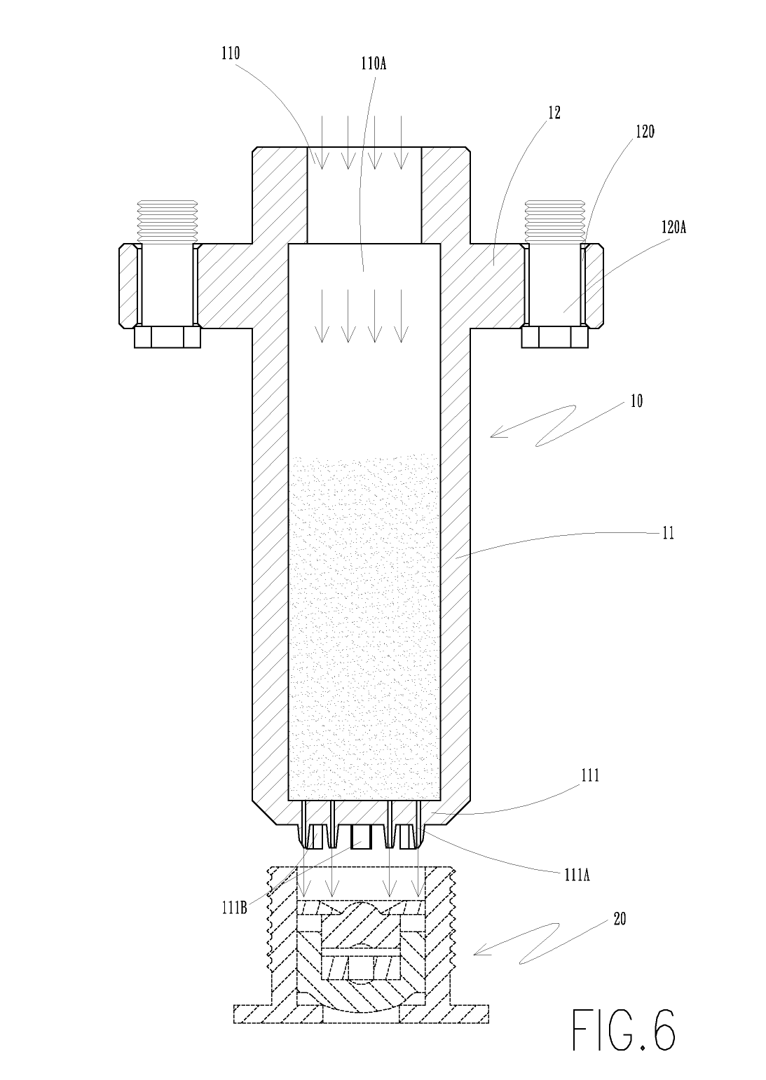

FIG. 3 is an enlarged view according to the preferred embodiment of the present invention. FIG. 4 is a bottom view according to the preferred embodiment of the present invention. FIG. 5 is a partial bottom view according to the preferred embodiment of the present invention. FIG. 6 is a schematic view of the preferred embodiment of the present invention in an operation state. The needle heads (111A) and the protrusions (111B) on the outer surface of the closed end (111) of the glue storage cylinder portion (11) are spaced from one another at 60 degrees. The connection seat portion (12) is connected to a retaining mechanism (not shown in the drawings) through the connection holes (120) cooperating with a plurality of connection members (120A). When in use, the needle heads (111A) and the protrusions (111B) at the closed end (111) of the glue storage cylinder portion (11) are perpendicular to a lens module (20) to be processed. Through the plurality of needle heads (111A) disposed around the closed end (111) of the glue storage cylinder portion (11), the glue drips on the periphery of the lens module (20) evenly. There is no need to move the needle body (10) for dripping glue many times. The present invention provides a stable glue-dripping, without worrying about deflection of glue, much glue or less glue.

The advantages of the present invention are as follows:

1. Smooth glue-dripping: The needle body is connected to the retaining mechanism through the connection holes of the connection seat portion. The needle heads and the protrusions at the closed end of the glue storage cylinder portion are perpendicular to the lens module to be processed. Through the plurality of needle heads disposed around the closed end of the glue storage cylinder portion, the glue drips on the periphery of the lens module evenly. There is no need to move the needle body for dripping glue many times. The present invention provides a smooth operation for glue-dripping.

2. Stable glue-dripping: The needle body is connected to the retaining mechanism through the connection holes of the connection seat portion. The needle heads and the protrusions at the closed end of the glue storage cylinder portion are perpendicular to the lens module to be processed. Through the plurality of needle heads disposed around the closed end of the glue storage cylinder portion, the glue drips on the periphery of the lens module evenly. There is no need to move the needle body for dripping glue many times. The present invention provides a stable glue-dripping, without worrying about deflection of glue, much glue or less glue.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A glue-dripping needle structure, comprising:
a needle body, the needle body comprising a glue storage cylinder portion and a connection seat portion, the connection seat portion having a plurality of connection holes, the glue storage cylinder portion having an open end and a closed end, the open end having a glue storage trough therein, an outer surface of the closed end being provided with a plurality of needle heads, the needle heads communicating with the glue storage trough of the open end.

2. The glue-dripping needle structure as claimed in claim 1, wherein the connection seat portion is disposed at an upper section of the glue storage cylinder portion.

3. The glue-dripping needle structure as claimed in claim 1, wherein the needle heads on the outer surface of the closed end of the glue storage cylinder portion are spaced from one another at 60 degrees.

4. The glue-dripping needle structure as claimed in claim 3, wherein the outer surface of the closed end is provided with a plurality of protrusions which are located between the needle heads and spaced from one another at 60 degrees.

5. The glue-dripping needle structure as claimed in claim 1, wherein the connection seat portion is connected to a retaining mechanism through the connection holes cooperating with a plurality of connection members.

6. The glue-dripping needle structure as claimed in claim 1, wherein the needle heads and the protrusions at the closed end of the glue storage cylinder portion are perpendicular to a lens module to be processed when in use.
